(19) United States
(12) Patent Application Publication
(10) Pub. No.: US 2014/0224134 A1
(43) Pub. Date: Aug. 14, 2014

(54) DEVICE FOR FILLING FLESHY FRUITS AND VEGETABLES

(71) Applicant: PATHAK HOLDINGS, LLC, Pheonix, AZ (US)

(72) Inventors: Chandrashekhar P. Pathak, Pheonix, AZ (US); Nivedita C. Pathak, Pheonix, AZ (US)

(73) Assignee: PATHAK HOLDINGS, LLC, Pheonix, AZ (US)

(21) Appl. No.: 14/258,695

(22) Filed: Apr. 22, 2014

Related U.S. Application Data
(62) Division of application No. 12/955,313, filed on Nov. 29, 2010.
(60) Provisional application No. 61/264,878, filed on Nov. 30, 2009.

(51) Int. Cl. A23P 1/08

(52) U.S. Cl. CPC A23P 1/087
USPC 99/493; 99/538

(57) ABSTRACT

Systems and methods for filling a fleshy fruit or vegetable with a filler are described. Embodiments include tool having an expandable member that is expandable to an expanded position to make a cavity in the fruit and collapsible to a collapsed position for withdrawal from the fruit, with the expandable member in the expanded state comprising a cross-section that is larger than the maximum diameter of the tool in the collapsed position. A cavity may be created without substantially affecting the natural visual appearance of the fruit or vegetable. Fillers and filling methods are disclosed.

### CROSS REFERENCE TO RELATED APPLICATIONS

This patent application is a divisional application of U.S. Ser. No. 12/955,313 filed Nov. 29, 2010, which claims priority to provisional application U.S. 61/264,878 filed Nov. 30, 2009, which patent applications are hereby incorporated herein by specific reference in their entirety.

### TECHNICAL FIELD

The technical field is directed to methods and compositions for preparing foods for human or animal consumption, and includes the filling of fruits or vegetables with fillers.

### BACKGROUND

Good nutrition occupies a central place in human health. Many approaches are known for enhancing nutritional value of foods. For instance, breakfast cereal or milk is often fortified or enhanced with vitamins and minerals. Even genetic engineering has been employed to enhance nutritional value of foods.

### SUMMARY OF THE INVENTION

A new way to enhance nutritional value is described herein that involves placing nutrition-enhancing substances into fruits or vegetables. The substances are placed in cavities inside the food. The cavities have a significant size but only small holes are made in the food when creating the cavities. Special tools for making the cavities are used. Flavor-enhancing additives may also be used, with the additional flavors increasing the desirability of eating the food.

One embodiment relates to a method for treating a fleshy food comprising: passing a tool into the food through an opening; making a cavity inside the food with the tool, with the cavity comprising a cross-section that is too large to be passed through the opening; and withdrawing the tool.

Another embodiment relates to a food composition comprising a filler in an artificial cavity or artificially modified natural cavity internal to a food, with the food having an opening into the cavity, with the cavity comprising a cross-section that is too large to be passed through the opening.

Other embodiments relate to a tool having an expandable member that is expandable to an expanded position to make a cavity in the food and collapsible to a collapsed position for withdrawal from the food, with the expandable member in the expanded state comprising a cross-section that is larger than the maximum diameter of the tool in the collapsed position.

Other embodiments relate to a tool having a plurality of lumens, and methods of using such tools to remove a portion of a food.

Other embodiments relate to creating a plurality of cavities and/or tunnels in a food. The cavities may be of any dimension relative to the opening used to create the cavity. The cavities may use the same or different openings in the food. The cavities and/or tunnels may be filled.

Other embodiments relate to placing a seal over an opening in a food. The seal may provide prevent exposure to air and/or resistance to contamination by microbes or pathogens. In some cases, such openings lead to a filled cavity, while in other cases the opening is made for other methods, for instance, infusion of agents or carbonation.

### BRIEF DESCRIPTION OF THE DRAWINGS

FIG. 1A is a perspective view of an expandable tool for filling a fleshy food with a filler;

FIG. 1B is a longitudinal cross-section of the tool of FIG. 1, with the expandable member in a collapsed position;

FIG. 1C is a longitudinal cross-section of the tool of FIG. 1, with the expandable member in an expanded position;

FIG. 2A is a cross-sectional view of a banana with the tool of FIG. 1A in place;

FIG. 2B is a cross-sectional view of a banana with the tool of FIG. 2A in place, with a manifold and tubing connected for filling;

FIG. 2C is a cross-sectional view of a banana with the tool of FIG. 1 in use;

FIG. 2D depicts a fleshy food filled using the tool of FIG. 1;

FIG. 3A depicts an expandable tool and system for filling a fleshy food with a filler;

FIG. 3B depicts the tool of FIG. 3A in a collapsed position;

FIG. 3C depicts the tool of FIG. 3A in an expanded position;

FIG. 4A depicts a self-expanding member;

FIG. 4B depicts a plurality of the members of FIG. 4A assembled into an self-expanding group;

FIG. 4C depicts a sheath for the tool of FIG. 4A;

FIG. 4D depicts the tool of FIG. 4A in a collapsed position;

FIG. 4E depicts the tool of FIG. 4A in an expanded position;

FIG. 5A depicts a self-expanding tool for making a cavity;

FIG. 5B depicts the tool of FIG. 5A with its expandable member in a collapsed position;

FIG. 5C depicts the tool of FIG. 5A in an introducer;

FIG. 5D depicts the tool of FIG. 5D in use with the introducer of FIG. 5C;

FIG. 6A depicts a self-expanding member for making a cavity;

FIG. 6B depicts the member of FIG. 6A assembled as a tool;

FIG. 6C depicts the tool of FIG. 6B in use and in collapsed position;

FIG. 6D depicts the tool of FIG. 6B in use and in an expanded position;

FIG. 7A depicts a vacuum-based cavity-making tool;

FIG. 7B is a cross-sectional view along the line B-B of FIG. 7A;

FIG. 8A depicts a tool with an expandable member in an expanded position;

FIG. 8B depicts the tool of FIG. 8A with the expandable member in a collapsed position;

FIG. 9A depicts a tool with an expandable member in a collapsed position;

FIG. 9B depicts the tool of FIG. 9A with the expandable member in an expanded position;

FIG. 10A is a schematic depiction of a filler in a flat configuration;

FIG. 10B depicts the filler of FIG. 1 OA in a rolled-up shape;

FIG. 10C depicts an opening in a food; and

FIG. 10D depicts the filler of FIG. 10B inside the opening of FIG. 10C.

### DETAILED DESCRIPTION OF THE INVENTION

Special tools for making the cavities in a fruit or vegetable are described herein. The tools can make large cavities through small access sites. Flavor-enhancing fillers may also be used, with the additional flavors increasing the desirability of eating the food.

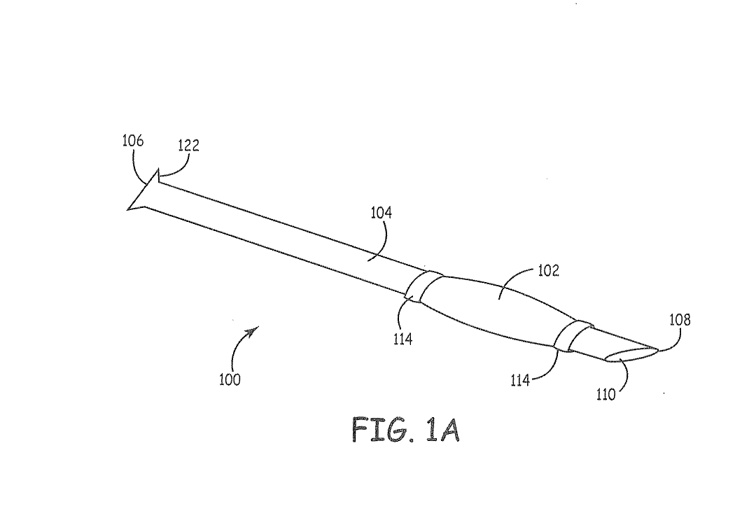

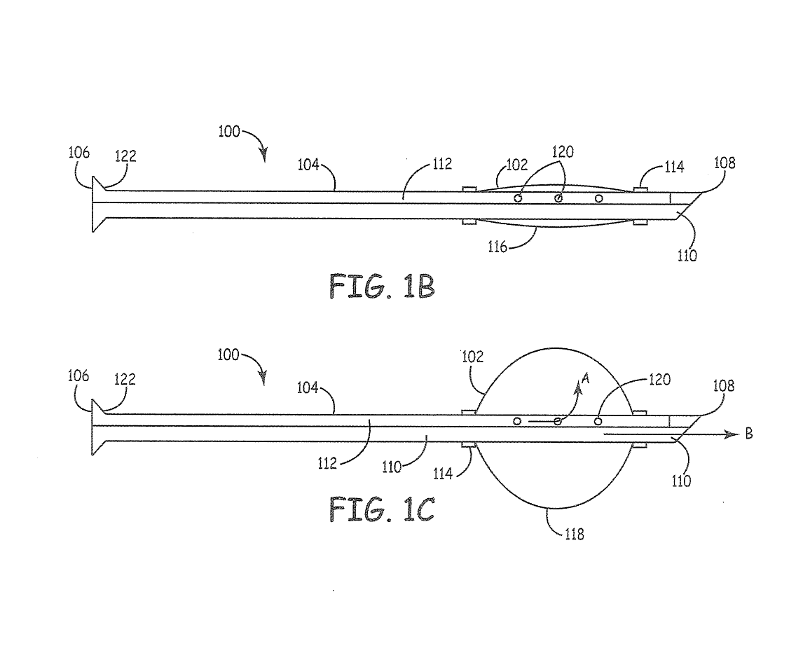

FIGS. 1A-1C depict tool 100 for creating a cavity in a fleshy food. Tool 100 has expandable member 102 on tube 104 that has proximal end 106, distal tip 108, and dual lumens, 110, 112. Expandable member 102 is a balloon that is secured to tube 104 by fasteners 114. Expandable member 102 has a first fully collapsed state 116 (FIG. 1B) and a second expanded state 118 (FIG. 1C). Member 102 is expanded or collapsed by forcing fluid in or out of the balloon through lumen 112, which has a first opening at the proximal end of tube 104 and a plurality of openings 120 into the interior of the expandable member 102. Arrow A of FIG. 1C indicates flow of liquid and/or gas through lumen 112 into the member. The other lumen 110 has a proximal opening at proximal end 106 and a distal opening at distal tip 108, and is available for passage of gas or liquids through, and out of the tube. The term proximal and distal are employed with reference to a user handling the device in its intended mode of operation, with the proximal end being closest to the user and the distal end being inside a fleshy food. Tube 100 has a connector 122 for ready connection to establish fluid communication with other tubes or devices. Connectors for tubes are well known, including, for instance, LUER LOK or friction-fit systems.

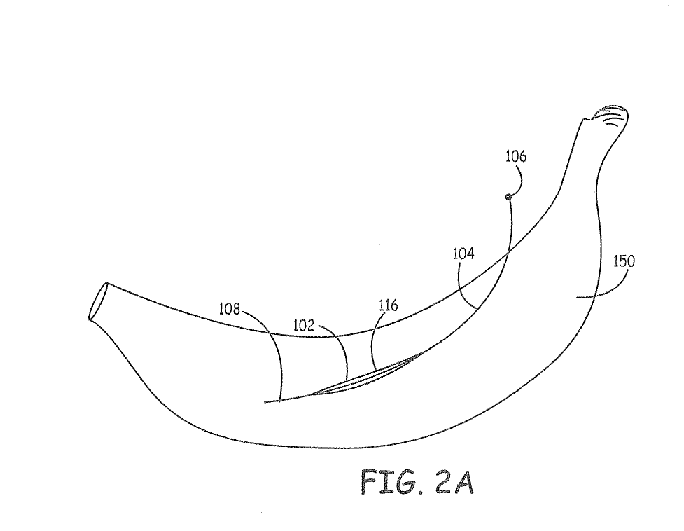

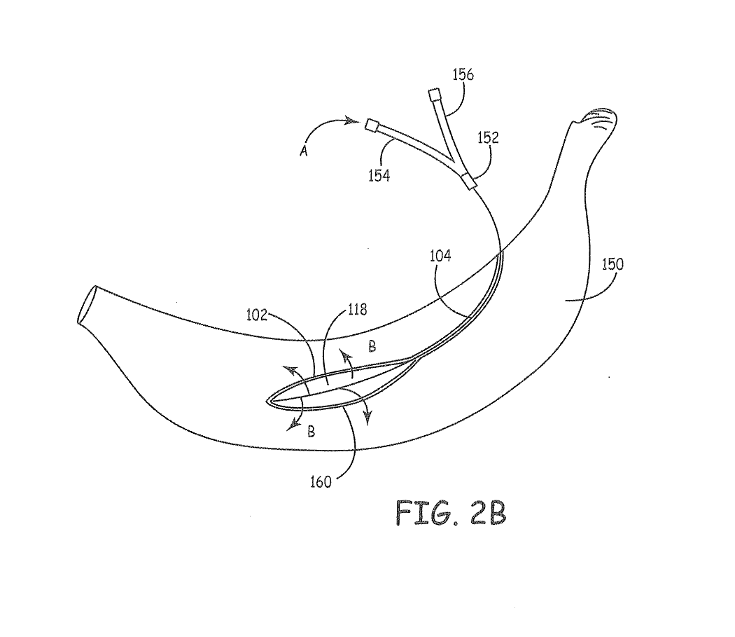

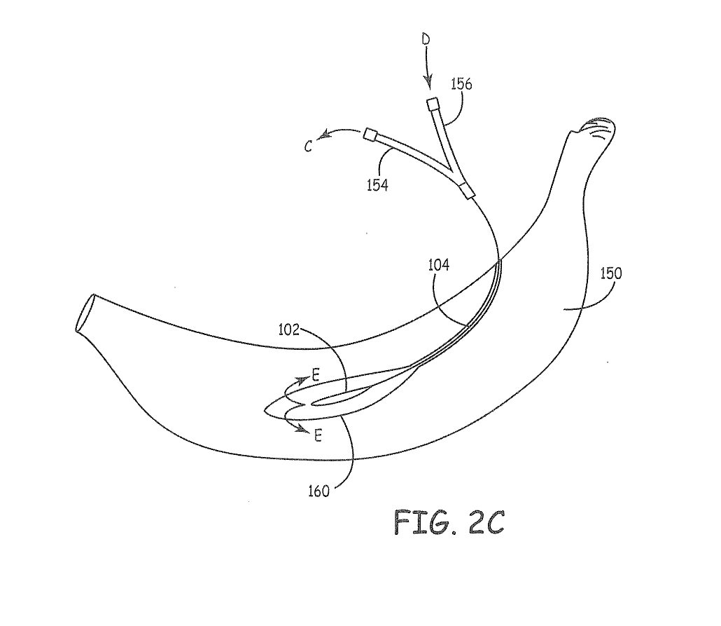

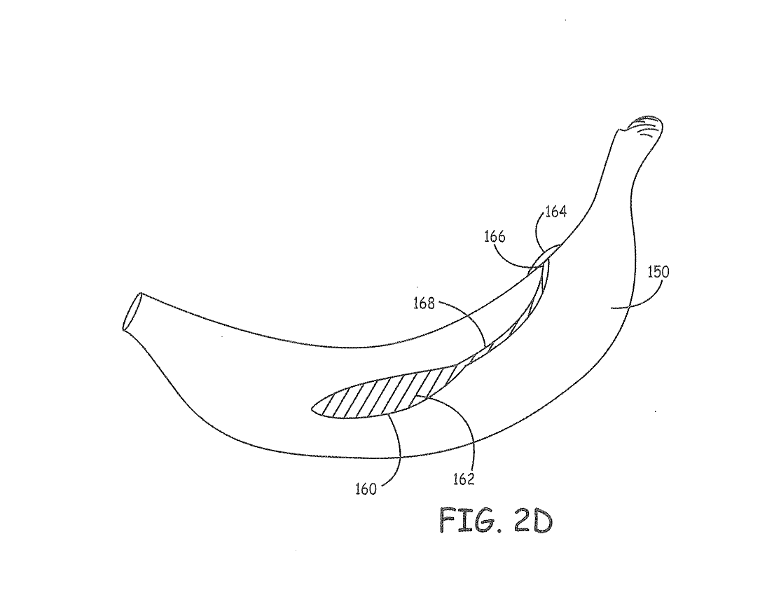

FIGS. 2A-2D depict the device of FIG. 1 in use. In FIG. 2A, tube 104 is forced into fruit 150. The fruit may be secured in a desirable position with a human hand and the area to receive the point of entry is sanitized, e.g., with alcohol swab. Manifold 152 having tubes 154, 156 fluidly communicating with lumens 112, 110 respectively, is attached to connector 122 and fluid is forced through tube 154 into expandable member 102 through lumen 112, as depicted in FIG. 2B with arrow A, which also depicts balloon expansion with arrow B to thereby create cavity 160. The expanded member 118 can be held stationary and deflated, or moved to create a larger cavity. For instance, a user may push and/or pull tube 104, or rotate it. Moving and expanding may be performed at the same time, or at separate times. FIG. 2C depicts collapse of member 102 by withdrawal of its contents through tube 154 as indicated by arrow C. A flowable material (for instance: fluids, gas, solids, slurries, pastes, and gels) is introduced through tube 156 of manifold 152 through lumen 110 into cavity 160, as depicted by arrows D and E in FIG. 2C. A filler intended to remain inside the food may be immediately introduced, or a flushing step may be performed. A filler 162 for the food is introduced into the cavity through tool 100 and the tool is withdrawn, with the withdrawal and filling being preformed simultaneously or in separate steps. A closure 164 is placed over opening 166 of access path 168 that leads to cavity 160.

The cavity 160 comprises a cross-section that is too large to be passed through opening 166. For instance, many cross-sections through cavity 160 would show a roughly circular hole with a diameter much larger than the diameter of opening 166; no matter how this hole is turned or maneuvered, it can not pass through the opening. In contrast, if the cavity and opening were made with a tube of unchangeable diameter, then a cross-section through the cavity could always be passed out through the opening. The term to pass through the opening refers to passing from the cavity and through any access path that might be present and thence out the opening, with no expansion of the opening/access diameter, so that the imaginary cross-section through the cavity has to pass through the smallest point of access to the cavity. The term opening in this context thus refers to a minimum access size that is the choke point through which a tool has to pass. In general, this will be equal to the hole in the outer surface of the skin.

The cavity can be any shape, and may be formed with the balloon-based expandable member or other tools as described herein. Similarly, the opening may be any of a variety of shapes; for instance, a sphere, a hemisphere, a cone, a cube, a polyhedron, a cylinder and nonsymmetrical or irregular shape. Thus a cross-section of the cavity, or the opening, may have a shape chosen from the group consisting of a circle, an ellipse, and a rectangle. The size and shape of cavity created inside the fruit may vary from intended use and the type of fruit used. Various shapes of cavity that can be created include various symmetrical or unsymmetrical shapes. The shapes of the cavity include but not limited to: irregular shaped, spherical, oval, cubical cylindrical, conical and the like. The volume of the cavity created may vary from size of the fruit and may vary from about 0.005 ml to about 1000 ml; artisans will immediately appreciate that all the ranges and values within the explicitly stated ranges are contemplated, e.g., about 0.01 ml to about 100 ml, or about 0.1 ml to about 20 ml. One, two, three or several cavities can be created inside the fruit. The multiple cavities can be created from single point of entry or may be created by the use of multiple entry points.

The opening on the food surface may be controlled across a wide range of sizes. The preferred average diameter of the opening (minimum access size) may vary from about 0.1 mm to about 50 mm; artisans will immediately appreciate that all the ranges and values within the explicitly stated ranges are contemplated, e.g., from about 0.5 mm to about 3 mm, or from about 1 mm to about 2 mm. The size of inner cavity is generally larger than the size of the opening. The ratio of average diameter of inner cavity to the opening may vary from about 1 to about 100; artisans will immediately appreciate that all the ranges and values within the explicitly stated ranges are contemplated, e.g., about 1 to about 20, about 1.5 to about 10.

The access path (also referred to as a tunnel) from the opening to the cavity may be controlled to have a predetermined length. Bends and curves may also be provided, e.g, a bend of at least about thirty degrees between the opening on the food's outer surface and the cavity. Some embodiments employ such a bend in the range of from about 5 to about 120 degrees; artisans will immediately appreciate that all the ranges and values within the explicitly stated ranges are contemplated, e.g., 45 degrees or from about 10 to about 90 degrees. A tunnel may be created with a length as desired, e.g., from about 1 to about 600 mm; artisans will immediately appreciate that all the ranges and values within the explicitly stated ranges are contemplated, e.g., about 50 to about 150 mm. For example, about 2 to about 3 mm diameter, about 50 to about 150 mm length is appropriate for small water melon, but may not be suited to a small apple or pear. The shape of the tunnel created may be circular, oval, rectangular, triangular, pentagonal, hexagonal, or irregular shaped. A circular or oval shape tunnel is suited to many tools, especially medical device tools that are commercially available, create access paths in a circular form. A tunnel diameter may vary according to the tool used. Generally it may range from microns to few centimeters, e.g., from about 0.2 mm to about 10 mm; artisans will immediately appreciate that all the ranges and values within the explicitly stated ranges are contemplated, e.g., about 0.5 mm to about 3 mm, or about French size 3 to 34. Once the tunnel is created inside the cavity, another tool or the same tool (tools may be dual or multipurpose tools) may be used to create a desired cavity at a desired location inside the fruit. For example, in one exemplary embodiment, a VACORA biopsy device with a sterile 10 gauge needle is used to cut a small amount of fruit flesh. After cutting the flesh, the tool is retrieved and the reinserted again to cut additional fruit flesh. This operation is continued until desired volume of the cavity is created.

More than one cavity may be placed into a food. The same or different opening may be used for the plurality of cavities. One method is to insert the same tool through the same opening with a different orientation so as to make a distinct cavity. Or the new cavity could overlap with the previous one to make a single combined cavity.

A variety of materials are available for making a balloon for an expandable member. One such material is a polyether block amide (PEBA) that is a thermoplastic elastomer (TPE). It is also known under the tradename of PEBAX. It is a block copolymer obtained by polycondensation of a carboxylic acid polyimide with an alcohol termination polyether. PEBA is a high performance TPE. Other materials and TPEs are available that artisans may use to create balloons after reading this disclosure. In one exemplary embodiment, an ATLAS high pressure balloon from C. R. Bard is used to create a cavity and pressure up to 20 atmospheres or higher is used to make a cavity. Non-compliant balloons are generally preferred in this application. The advantage of balloon is that it can be inserted using a narrow opening, and then expanded into fairly large size in situ at a desired place inside the food. The balloons are typically inflated by injecting saline or other media in the balloon cavity using a syringe or specialized inflation devices with a pressure gauge. After a desired inflation and pressure is reached, the inflation fluid is withdrawn and the balloon is deflated and can be pulled from the narrow cavity. Balloon-based devices are known in the medical arts ad may be adapted to methods as set forth herein. For instance, many angioplasty catheters are multi-lumen devices and two or more lumens are used for different purposes. If desired, the insertion, transportation, inflation and deflation can be monitored using an x-ray imaging machine, or other imaging devices. The tube for the tool may be made of a variety of materials. Metals and engineering plastics are available to make a tube that is either rigid or stiff with some flexibility for insertion into a fleshy food.

Multipurpose tools which can do multiple tasks may be used. The multitasking tools include tools that can cut, grind as well as suction the ground particles out of the fruit body are preferred. Such multipurpose or multitasking tools may be deployed using a catheter or tube with two, three, four or more lumens. The device of FIGS. 1 and 2 is depicted with two lumens. One lumen, however, may be used, with the lumen being dedicated to fill/deflation of the balloon. In this embodiment, the tool is withdrawn and another tube placed into the cavity for washing and/or filling. More than two lumens may also be used, e.g., at least two, at least three, or between 3 and 5. Manifolds may be used to dedicate a lumen to fill/deflation, filling, washing, vacuuming, or sensing (pressure, temperature, liquid vs gas). Manifolds may also be made to switch a lumen from one task to the other. Artisans reading this disclosure will be able to adapt the arts of connection and manifolding of tubes to achieve these features. Each lumen in the tube may be used to perform a different function. The tools used to create a cavity may be equipped with sensors that can assist in creating the cavity and infusion process. These sensors include but limited to: camera to visually observe the operations, temperature sensors or infrared sensors to monitor and record temperatures, pressure sensors, pH and other type of chemical sensors, sugar sensors, and the like.

One advantage of this invention is that the external visual appearance of the food may be substantially unchanged. However, the agents incorporated inside the food surface using methods described above, add a value such as nutritional value, taste, texture and the like and differentiates this food from other fresh foods.

The openings created by a tool may be sealed after completing the desired operations. The sealing of the openings may be done to prevent microbial contamination, oxidation or other chemical effects due to exposure to air and it may also provide a space to promote the brand or advertisement. Many types of adhesives or sealant may be used to seal the access port. In one exemplary embodiment, the access port is sealed by a paper or textile based sticker or adhesive strip that is coated on one side with a food grade adhesive or sealant which is capable of adhering to the fruit surface and can provide an air tight sealing, is used. The other side of the sticker is printed with company logo and product brand name. Many types of adhesives can be used on the sticker; the preferred adhesive materials are those which are approved by the FDA. National Adhesives, Bridgewater, N.J., BASF Corporation, Germany and many others offer variety of adhesives for food applications. BASF offers ACRESIN® A 204 UV adhesive for permanent applications offering high cohesion; ACRESIN® DS 3532 for removable and freezer applications; and ACRESIN® DS 3552 for high coat weight permanent applications and beverage labeling. The technical information on the use of ACRESIN DS 3532 can be found on the company web site or can be obtained from the company when a product is purchased. Other types of sealant materials that could be used are wax, starch based adhesives, chocolate based compositions and the like. U.S. Pat. Nos. 5,410,016 and 6,566,406, hereby incorporated herein by reference, provide compositions for sealing materials. Other materials such as fibrin sealant also could be used. In one exemplary embodiment, a fresh papaya fruit cavity is filled with ice cream. A 2 mm opening is covered with a paper-based sticker or sealant and rest of the fruit is identical or substantially similar to the unprocessed papaya fruit. If desired, multiple injections may be made to achieve a desired concentration of an agent. The entry port is sealed using an adhesive backed paper and/or food grade sealant. In some cases, en external wax coating or other food-safe sealant coating may be applied to seal the injection site. The seal may be applied to an opening created by a tool as described herein, or may be applied to any other opening. Embodiments thus include a seal over an opening in a food object.

A fleshy food refers to a fleshy fruit or a fleshy vegetable. A fleshy food has a soft portion with a watery content. Examples include fleshy fruits, fleshy vegetables, apples, pears, bananas, watermelons, most melons, many gourds, potatoes, tomatoes, apple, banana, figs, lemons, grapes, guavas, jackfruit, mango, mulberry, muskmelon cantaloupe, orange, papaya, pear, pineapple, plum, pomegranate, lime, watermelon, and coconut. The food may or may not have a hard seed, e.g, peaches. Vegetables include, for example, beetroot, carrot, cauliflower, green chili, cucumber, eggplant, french beans, gooseberry, bell pepper, onion, jackfruit, mango, mushroom, okra, plantain, potato, pumpkin, sweet potato, tomato, and yam. As is evident, some of these foods are relatively small compared to the banana depicted in FIGS. 1-2; the tools' dimensions may be adjusted accordingly.

Once the cavity is created inside the food, the cavity can be filled, coated or infused with a filler (also referred to as an agent). Such fillers may include, for example, agents that enhance the nutritional value, the flavor, the sweetness, or the crispness of the food. The term agents refers to exogenous materials introduced into the food that are compositions, compounds, substances or ingredients that enhance the nutritional, commercial or economic value of a fruit. Various agents are disclosed: these may be combined as desired. These may also be microencapsulated and introduced by themselves or in combination with other agents. Agents include but not limited to: flavoring agents and compositions, nutraceuticals, sauces, curries, chutnies (Indian sauces), pickles, salad dressing, coloring compositions, phytochemicals, spices, fragrances, nutritional supplements, salts, gas such as carbon dioxide, minerals, buffering agents, antioxidants, stabilizers, quality enhancer compounds, protein powders, milk powders, dairy products, vitamins, herbs, herbal extracts and herbal medicines, sweeteners, texturizers, fragrance enhancing compositions, biologically active compounds or drugs and the like and their combinations. The term nutraceutical refers to any compositions or chemicals that can provide dietary or health benefits when consumed by humans or animals. Examples of nutraceuticals include vitamins, minerals, and others. Fillers include, for example, one or more of ice cream, fruit, jelly, cream, chocolate, yogurt, fruit jelly, gelatin, JELL-O gelatin, sugar, artificial sweetener, peanut butter and/or salad dressing. An agent may include one or more spices, for example: ginger, celery or radhuni seed, parsley, carom seed, indian gooseberry, pomegranate seed, black cardamom, almond, green cardamom, star anise, charoli, buchanania latifolia, mango extract, cinnamon, coriander seed, cardamom, garam masala spice mixture, rosewater, unrefined sugar date palm, turmeric, coriander, myrobalan chabulic, green chili, honey, asafoetida, tamarind, jaggery, nutmeg, mace, cumin, licorice, capers, curry tree, cashewnut, black salt, black peppercorn, nigella seed, dried fenugreek leaf, tragacanth gum, saffron, dates, garcinia indica, poppy seed, garcinia cambogia, garlic, cred chili, cloves, fenugreek leaf and seeds, sarson tel mustard oil, naaga keshar, namak salt, nimbu lemon, mint, onion, black pepper, panch phoron, black stone flower, yellow pepper, mustard seed, alkanet root, citric acid, fennel seed, black cumin seed, vinegar, dill, ginger powder, aniseed, citric acid, malabathrum, java peppercorn, sesame seed, holy basil, vanilla. Agents may include fragrances that are compositions and chemicals that provide a unique smell to the fruit composition and are suitable for human or animal consumption and these include, for example: diacetyl, isoamyl acetate, cinnamic aldehyde, ethyl propionate, limonene, ethyl-(e,z)-2,4-decadienoate, allyl hexanoate, ethyl maltol, methyl salicylate, and benzaldehyde. The agents may be flavoring agents, for example: nut flavor concentrates; the flavor of alcoholic beverages such as beer, wine, and whiskey; mint flavor; chocolate or other confectionery flavors; honey flavor; fruit flavors; and other desired artificial or natural flavor, and mixtures thereof.

In general an agent that is compatible with fruit flesh chemistry is preferred. For example, a yogurt with live bacteria culture may be not be compatible with fruit flesh as bacteria in fruit may affect the shelf life of fruit. In another example, a fruit that is normally stored in dry state such as a dry cashew nut or preserved dry apricot may not tolerate an agent that contains high amount of free water such as fruit jelly or JELL-O. The water from the agent may adversely affect the nut or dry fruit shelf life, taste or texture of the fruit. Agents may include bioactive agents. The term bioactive as used herein, refers to o a compound that show pharmacological activity in human or animal body that has a therapeutic effect. The bioactive compounds that can be used include, but not limited to: antiviral agents; antiinfectives such as antibiotics; antipruritics; antipsychotics; cholesterol or lipid reducing agents, cell cycle inhibitors, anticancer agents, antiparkinsonism drugs, HMG-CoA inhibitors, antirestenosis agents, antiinflammatory agents; antiasthmatic agents; antihelmintics; immunosuppressives; muscle relaxants; antidiuretic agents; vasodilators; nitric oxide, nitric oxide releasing compounds, beta-blockers; hormones; antidepressants; decongestants; calcium channel blockers; growth factors such as bone growth factors, wound healing agents, analgesics and analgesic combinations; local anesthetics agents, antihistamines; sedatives; angiogenesis promoting agents; angiogenesis inhibiting agents; tranquilizers and the like, enzymes, therapeutic proteins, vaccines, antibodies, viruses, DNA, RNA, genes may also be included as bioactive components. Agents may be a herbal medicine, which means plants, animals and mineral based compositions that have used by traditional Indian or Chinese practitioners and may include but not limited to: Yin Chen, Fang Feng, Fu Ling, Hua Xiang, Bai Zhi, Wu Wei Zi, Bai Shao, Dang Shen, Mu Xiang, mahasudarshan kadha, thribhuvankirti, kutajarishta, chavanprash and the like. An example is peanut butter filled celery that represents a significant change in the celery composition wherein peanut butter provides a protein and fat content which may improve its taste and appeal to wide range of tastes.

An agent may be prepared in an injectable form so that it can be transported through a narrow opening created during the cavity preparation. More specifically, the injectable compositions can converted into fluid or semisolid or liquid state and then injected in the cavity and permitted to gel or solidify. Many gelling mechanisms can be used. Many gelling agents are available for food chemists and can be found in a book and references therein entitled Thickening and Gelling Agents for Food 2nd Edition edited by Alan Imeson, hereby incorporated herein for reference. Agents may include compositions that melt and then solidify, ionically gelling compositions like sodium alginate gelling with calcium ion solution, compositions that are liquid when hot or warm and then form a gel at ambient temperature (like JELLO, or gels, or gelatins) and the like. A gelatin solution is liquid at warm temperatures but forms a gel at cold temperature or at ambient temperatures may also be used. Additives like PLURONIC surfactant may be also be used. PLURONIC surfactants form a low viscosity injectable solution at 20° C. or lower temperature but form a gel at ambient temperature or at body temperature. Such compositions are generally known as thermosensitive gels. In one exemplary embodiment, a chocolate based composition that melts at warm temperature is melted by heating to form a liquid or semisolid, then transported to the fruit cavity as a filling, and then permitted to cool and solidify.

Encapsulation may be used on the agents. Embodiments include microencapsulated agents. These agents or encapsulation may be used for any suitable purpose, with embodiments as set forth herein being by way of example only. The agent composition, particularly injectable compositions, may be microencapsulated. Microencapsulation technology has many known applications in food chemistry. The microencapsulation technology may be especially used for agents, which have known health benefits but have a bitter or unlikable smell, or odor. Microencapsulation also protects agents which may be sensitive to handling or otherwise subject to degradation during the infusion operation or storage of the resulting fruits. Some of the drugs could be especially useful in microencapsulated form. It is possible to microencapsulate them in a suitable matrix and inject them in the fruit cavity. The microencapsulation matrix also could be used to control the release of the agent. For example, an agent that is targeted to be released in acidic environment of stomach could be designed and used. Application of controlled release technology in food industry is also covered by Desai et al. and Gharsallaoui et al.

Artisans will appreciate that many agents can be encapsulated and then incorporated in foods. Microencapsulated particles can come in many shapes such as spherical, elliptical, hollow spheres, conical, cubical, irregular and the like. The size of microencapsulated particles may range from about 0.1 microns to a few millimeters; artisans will immediately appreciate that all the ranges and values within the explicitly stated ranges are contemplated, e.g., about 1 micron to about 1000 microns, or about 50 to about 700 microns. A size of the encapsulated microparticles may be smaller than the injection port of the device of device/tool used in injecting the microparticles in the fruit. The microencapsulation art reviewed by Desai et al. and references therein, could be used to obtain desirable microspheres for injection in the fruit. Gharsallaoui et al. reviewed applications of spray-drying in microencapsulation of food ingredients. (Gharsallaoui et al. “Applications of Spray-Drying in Microencapsulation of Food Ingredients: An Overview”. Food Research International, year 2007, 40, page 1107-1121; hereby incorporated by reference herein). Desai et. al. reports the recent developments in microencapsulation technology for food ingredients. (Desai, K. G. H.; Park, H. J. “Recent Developments in Microencapsulation of Food Ingredients. Drying Technology”, year 2005, 23, page 1361-1394; hereby incorporated by reference herein).

In one exemplary microencapsulation embodiment, a flaxseed oil is encapsulated in gelatin or alginate matrix and then the encapsulated microspheres are injected in the fresh ripe banana fruit. The purpose of microencapsulation is to mask the taste and odor of flaxseed oil while improving the nutritional value of an exemplary fruit like banana. Flaxseed oil is known to be rich in alpha-linolenic acid, an essential fatty acid that is believed to be beneficial for heart disease, inflammatory bowel disease, arthritis and a variety of other health conditions. Addition of flaxseed oil in the fresh ripe banana fruit can improve its nutritional value. In one mode, the addition of flaxseed oil is done in a manner that will not substantially change the physical appearance of the banana fruit. The microencapsulation helps to mask the perceived undesirable smell and taste of flaxseed oil. In the exemplary embodiment, oil water and surfactant are mixed to form a suspension. The suspension is mixed with sodium alginate gelling solution which gels when exposed to divalent or trivalent ions such as barium, calcium and the like. The alginate solution is mixed with the flaxseed oil suspension and the resultant mixture is converted into tiny droplets. The droplets are exposed to calcium ion solution and are converted to solid gel particles due to ionic crosslinking of sodium alginate with calcium ions. The flaxseed oil in the alginate solution remains entrapped in the alginate particles and thus is encapsulated in the gel microspheres. These flaxseed oil particles are then injected into banana flesh through the skin using syringe and a needle. Alternatively a cavity is first created in the banana and then flaxseed microspheres are filled inside the cavity. It is preferred to use a small one mm diameter or less port to inject microspheres so that external visual appearance of banana is substantially preserved. When a customer consumes the modified banana as prepared above, he/she peels the skin of the fruit and consumes the banana. The microspheres with flaxseed oil are also consumed along the fruit and provide the health benefit of flaxseed oil to the consumer. Further examples of a flaxseed oil encapsulated and used as a filler in a banana is detailed in Example 5 of the priority document U.S. Ser. No. 61/264,878 filed Nov. 30, 2009. Other oils may be similarly processed, for instance a fish oil.

Fish oils may be used as fillers and/or infused. Natural fish oils may be used, or synthetics based on fatty acids in the same. Agents include, for example, docosahexaenoic acid. Other fatty acids that can be used include a long-chain polyunsaturated omega-6 fatty acid, flaxseed oil, wall nut oil and the like. Agents include, for example, omega-3 fatty acids, eicosapentaenoic acid (EPA), docosahexaenoic acid (DHA), and precursors to eicosanoids that are known to reduce inflammation throughout the body. For instance, LIFE'SDHA or LIFE'SARA, are conunercially available microencapsulated oils from Martek Biosciences Corporation, Canada. Amounts and concentrations of materials may be provided as needed. Embodiments include a food having at least 0.1 mg exogenous omega acid, or between 0.1 mg a 2 g exogenous omega acid. Another agent is a coloring composition. The term coloring composition includes a colorant or chemical that is suitable for human or animal consumption and includes, for example: beet powder, canthaxanthin, caramel, β-apo-8′-carotenal, β-carotene, cochineal extract, carmine, sodium copper chlorophyllin, toasted partially defatted cooked cottonseed flour, ferrous gluconate, ferrous lactate, grape color extract, grape skin extract (enocianina), synthetic iron oxide, fruit juice, vegetable juice, carrot oil, paprika, paprika oleoresin, mica-based pearlescent pigments, riboflavin, saffron, titanium dioxide, tomato lycopene extract; tomato lycopene concentrate, turmeric, turmeric oleoresin, FD&C Blue No. 1, FD&C Blue No. 2, FD&C Green No. 3, Orange B, Citrus Red No. 2, FD&C Red No. 3, FD&C Red No. 40, FD&C Yellow No. 5, FD&C Yellow No. 6 and the like. The agent may be encapsulated. The coloring composition may be used with other agents.

A cavity-creation process may be preceded and/or followed by a stabilizing and/or a sanitizing step. In a stabilizing step, a food, e.g., a water melon, is secured using a clamp or human hand or by any other means. The device used for securing the fruit does not permit the fruit to move during the procedure and this helps in creating a cavity where it is intended to be. It also helps to obtain more consistent results. While securing the fruit, care is taken not to damage the fruit. Minimum or no damage to the fruit's visual appearance is preferred. Damage to visual appearance of the fruit may be avoided. Some fruits are soft and delicate and appropriate tools should be used to secure such fruits. A human hand is suitable to secure the fruit. Other mechanical grips that can mimic human hand grip may also be used. After securing the fruit, the whole fruit or a small area covering about 0.01 to about 20 percent of the fruit surface; artisans will immediately appreciate that all the ranges and values within the explicitly stated ranges are contemplated, e.g., about 0.5 percent to about 10 percent, or about 1 to about 5 percent of the fruit surface area is sanitized or sterilized. Sanitation and/or sterilization may be carried out by many methods known in the art of human or animal surgery. These methods include but not limited to iodine solution, alcohol solutions such as 70 percent alcohol solution, more specifically isopropanol solution, bleach solutions such as 10 percent Clorox bleach solution, antibacterial solutions such as chlorhexidene solution and the like. In some cases the entire fruit may be sanitized prior to treatment. The tool may be sterilized or sanitized prior to use, and/or in between uses on different foods.

Another process that may be included is a remote imaging process. A camera, monitor, or other videoimaging processes may be used to monitor progress. Internal imaging may be performed in a cavity using small remote cameras known in the medical arts, or as obtained from other sources.

Another step that may be included is a cooling and/or a freezing step. In some applications, it may be desirable to cool or refrigerate the fruit before creating a cavity. The cooling may be carried out by storing the fruit in refrigerator or liquid nitrogen cooling or other cooling methods known in the art may also be used. The reduction in temperature affects the physical properties of the fruit and makes it more workable with mechanical tools such as drilling, cutting, corking and the like.

Another step that may be included is use of an introducer tube. The introducer tube is pushed into the food and makes an access site. The tool is then passed through the introducer, and the expandable member is expanded outside of the introducer. Alternatively, or additionally, a device may be used to make a pilot hole or a first bore, by trocar, tube, spike, drill, or other means. Subsequent steps work through the hole and/or expand it. Embodiments include an introducer tube used in combination with a tool that removes at least a portion of a food object. Such tools may include devices as set forth herein, or other devices.

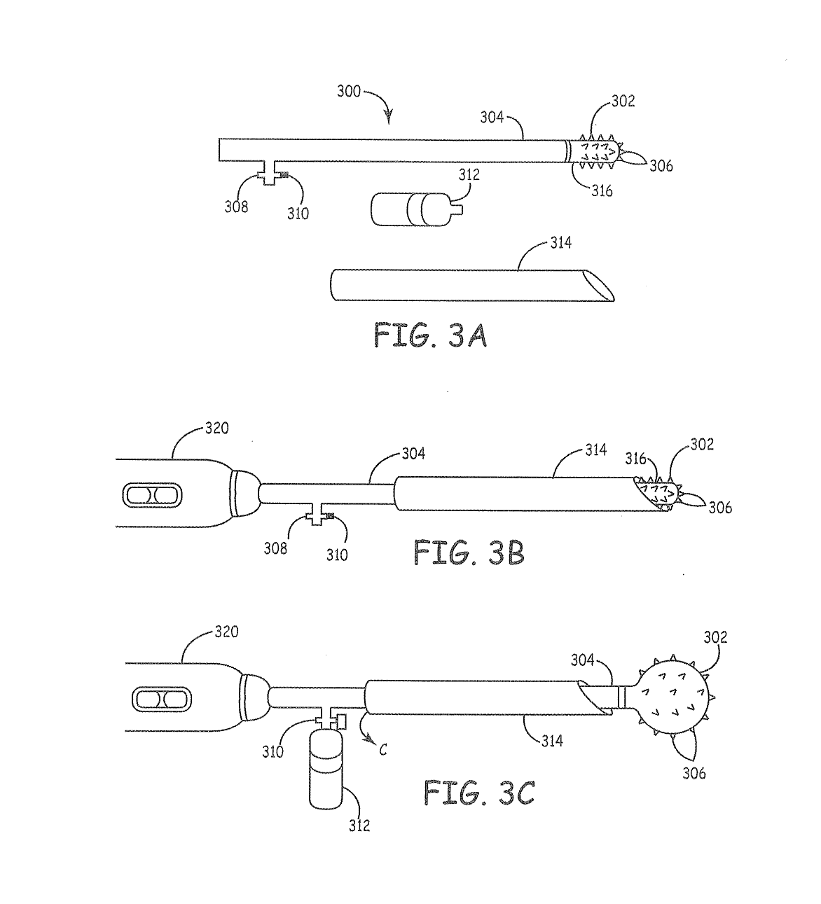

FIG. 3 depicts an introducer in the context of a balloon equipped with a plurality of burrs. Tool 300 has expandable member 302 mounted on tube 304. Member 302 has a plurality of burrs 306. Tube 304 has connector 308 controlled by stopcock 310. Pressurized container 312 (or optionally, other pressure source, e.g., a tube connected to a water source) is connectable to connector 308. Tube 304 has a lumen (not visible) that connects connector 308 to fill/deflate balloon 302. Introducer 314 is sized to fit over tool 300 when balloon 302 is in collapsed state 316. In use, introducer 314 is forced into a fleshy food while tool 300 is disposed therein and rotatably connected to a drill 320. Alternatively, the introducer may be forced in, and the tool pushed or drilled into its interior. Introducer 314 is withdrawn enough distance to reveal balloon 302, as at FIG. 3C. Drill 320 is operated to turn balloon 302, which is expanded by opening stopcock 310, see arrow C of FIG. 3C, to pressurize balloon 302. Burrs 306 may be hard material embedded in the balloon, e.g., diamond, metal, rigid plastic. Tool 300 may be withdrawn and fillers provided through the introducer, which is withdrawn and the opening optionally sealed.

Multiple lumen tools may also be used, with other lumens employed as described herein, e.g., for washing, suction, and/or passage of filler(s). Methods include a multi-lumen tool that removes at least a portion of a food item through at least one of the lumens. Such tools may be used to create a cavity that is larger than the opening, or any other sized cavity or opening.

In another embodiment, a specialized tool or tools are used to infuse an agent inside the food. A conforming balloon or compliant balloon with multiple needles is inserted inside a fruit cavity in its compressed form. The balloon is transported to a desired site inside the fruit cavity and is inflated using gas or liquid such as water. Upon inflation, needles on the surface of the balloon penetrate the fruit flesh and an injectable agent composition is injected into a fruit flesh. If desired multiple injections can be made to achieve a desired level of agent in the fruit. Upon achieving a desired concentration of agent, the balloon is deflated and the folded balloon is withdrawn from the cavity. In some cases, a perfusion balloon may also be used wherein the agent composition can be delivered at the junction of fruit and cavity surface using a perfusion mechanism through the balloon wall. The balloon is deflated and is inflated inside a fruit cavity. The inflated balloon surface conforms to the fruit cavity shape and the needles on the balloon surface are used to inject food useful ingredients. Those skilled in the art will recognize that many variations of inflatable/expandable injection tools are possible and are covered as a part of this invention. For example, shape memory based injection tool may be designed and used for injection of agent compositions inside the fruit body.

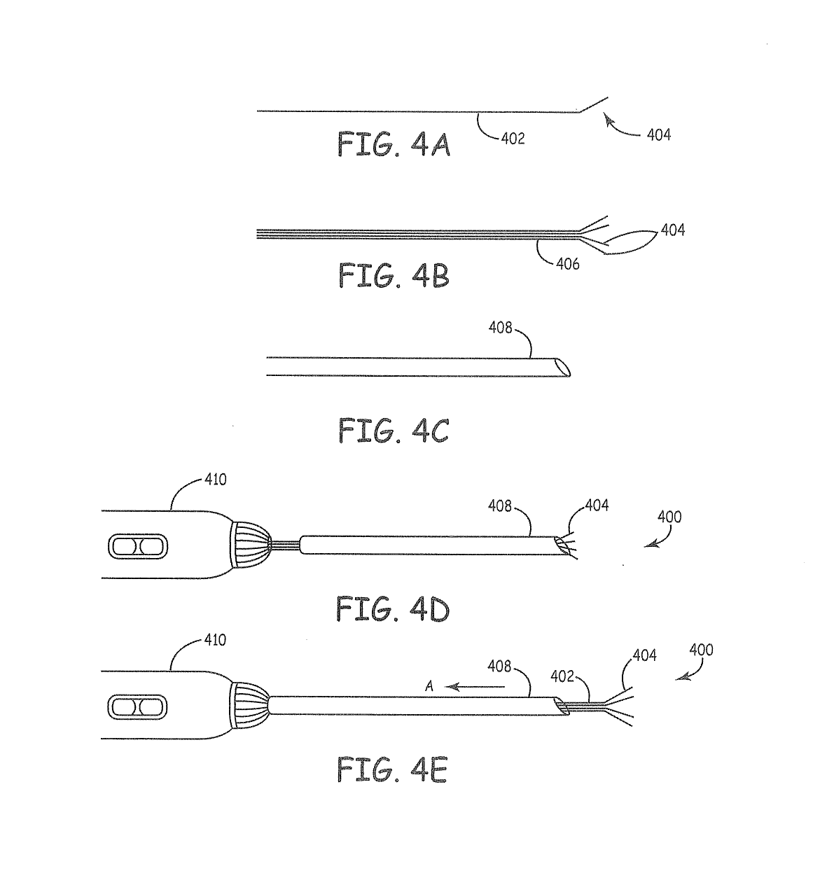

FIGS. 4A-4E depict an expandable member comprising one or more self-expanding wires in system 400, with the self-expansion being provided by the elasticity of the wires that tend to return to a resting eccentric position. One or more wires 402 with eccentric end 404 are joined together to make an expanding member 406 and fit inside sheath 408. Member 406 is fit to a drill 410, with eccentric ends 404 inside sheath 408. Sheath 408 is passed into a fleshy food and withdrawn to reveal bent ends 404 of wires 402, as at arrow A of FIG. 4E. Drill 410 rotates the wires to carve out a cavity. Drill 410, wires 402, and sheath 408 may be moved to create a cavity of desired dimensions. Ends 404 have a natural bias to an eccentric position so that their release from confines of sheath 408 allows them to bend outwardly and expand to their resting state as depicted at FIGS. 4A-4B. An angle of eccentricity of about 45 degrees is depicted, but the angle may be varied considerably, e.g., from 10 to 145 degrees. Member 406 may be withdrawn and fillers provided through the sheath, which is withdrawn and the opening optionally sealed. Multiple lumen sheaths may also be used, with other lumens employed as already described, e.g., for washing, suction, and/or passage of filler(s).

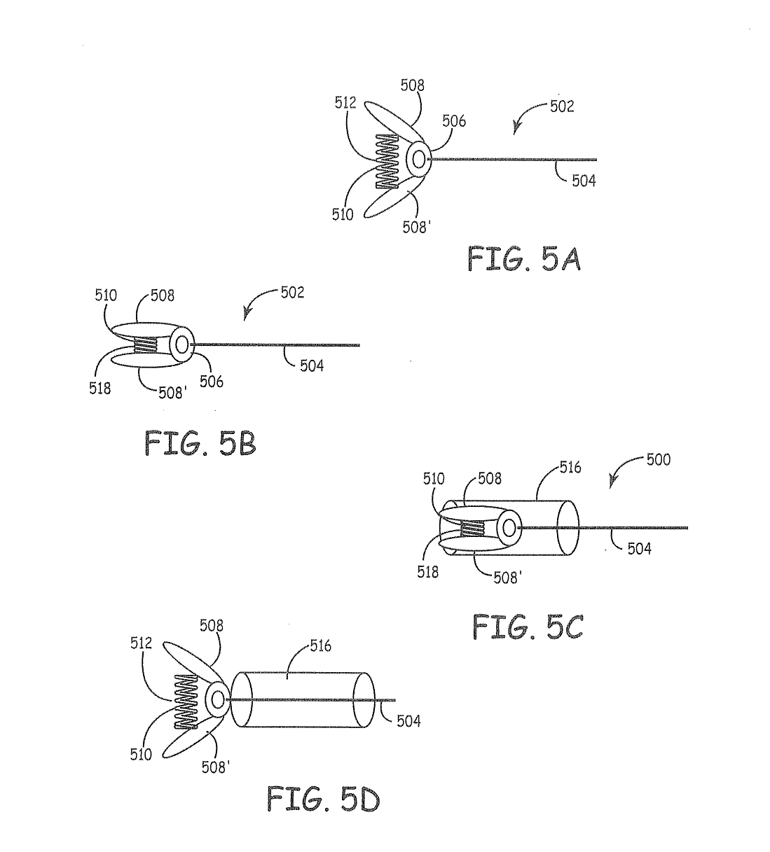

An expandable member may also comprise a spring or other biasing member for creating a bias for self-expansion, with the spring tending to force the member to the expanded state. FIGS. 5A-5D are a schematic depicting how such a member may be made and used. System 500 has a tool 502 that comprises a base 504 connected to expandable member 506, which has blades 508, 508′ pivotably joined to base 504. Spring 510 forces blades 508, 508′ apart in resting-expanded position 512. Tool 502 is placed inside an introducer 516 in a collapsed position with spring 510 in a collapsed position 518. In use, introducer 516 is forced into a fleshy food and tool 502 placed therein. The introducer is withdrawn and the expandable member expanded, with optional rotation, to create the cavity. Multiple lumens may be used, as has been described for other embodiments.

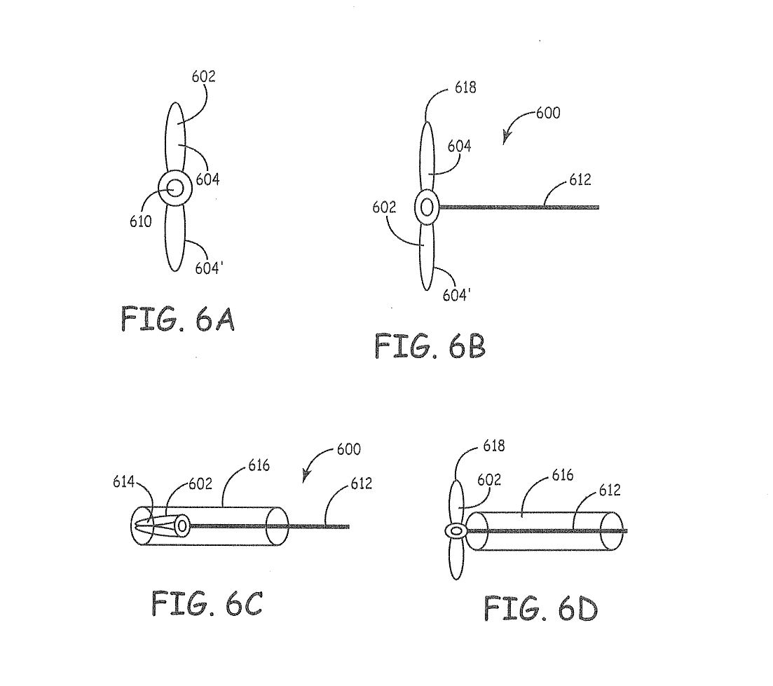

FIGS. 6A-6D depict tool 600 with an expandable member 602 that comprises one or more members made of a shape-memory alloy. FIG. 6A depicts cutting blades 604, 604′ stamped out from a nitinol alloy sheet. Mount 610 is provided for mounting to base rod 612, which may be connected to a drilling machine. The Nitinol alloy is programmed to remember the shape by heat treatment, e.g., at 500° C. for 10 minutes. Tool 600 is depicted at FIG. 4C in a collapsed position 614 with folded blades 604,604′ enclosed in tube 616. In use, the nitinol blades 604, 604′ are pushed out of tube 616 and regain memorized expanded shape 618. Proximal end of rod 612 is attached to a drilling machine and is rotated to create a cavity inside a fleshy food. Multiple lumens may be used, as has been described for other embodiments.

The drills for these devices can be simple drills that are familiarly available at hardware stores, or more sophisticated. For instance, drills are known in the catheterization arts that are high speed, as are dental drills. For example, a ROTABLATOR rotational atherectomy system from Boston Scientific could be used to create a cavity in fruit. By way of example, a 12 to 16 inch diameter watermelon is secured using a mechanical clamp. The clamp secures the fruit during the procedure but does not damage the fruit. Approximate one square inch surface of the fruit is cleaned/sterilized using an iodine solution. A sterile 14 gauge, 10 cm long stainless steel needle (Aldrich catalog Z117048) is first inserted 8 inch deep into the fruit through the cleaned/sterile site. The needle is removed a guidewire is inserted in the cavity created by the needle. A guidewire is used to insert the ROTABLATOR device. The tip of the ROTABLATOR is coated with very tiny pieces of diamond crystals. Air pressure (turbine) is used to power and rotate the tip at very high speeds against the fruit flesh. Short bursts of power is used to rotate the tip up to 190,000 rpm. The rotation of the ROTABLATOR tool grinds and/or breaks the fruit flesh down into very small particles which can be aspirated or removed. The tool is used to create a cavity of desired size. ROTABLATOR is available in variety of sizes and lengths and can be used to create variety of cavity sizes. After the procedure the ROTABLATOR tool or device is removed and the insertion port is sealed using a food grade paper sticker or a suitable food based sealant.

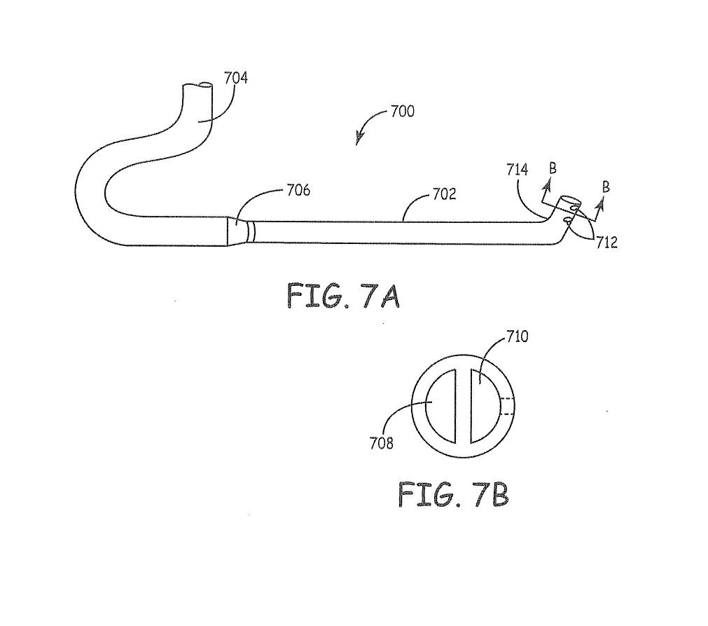

An alternative system 700 is depicted in FIG. 7. Bent tube 702 is connected to tubing 704 by connector 706. Tube 702 has lumens 708, 710, and holes 712 into lumen 710. Tube 702 has a bend at its distal portion 714 of about 45 degrees; the bend may be otherwise disposed, e.g., from 10 to 145 degrees; artisans will immediately appreciate that all the ranges and values within the explicitly stated ranges are contemplated. Alternatively, tube 702 may be substantially straight. In use, tube 702 is passed into a fleshy food and a vacuum applied through tubing 704 and lumen 710. The vacuum removes the flesh of the fruit or vegetable to make a cavity. The tube may be rotated and moved to make a cavity of a desired size. Multiple lumens may be used, as has been described for other embodiments. In the case of system 700, second lumen 708 is available. For instance a fluid may be passed into the cavity while suction is applied through lumen 708 to wash the cavity, or rinse the cavity to assist in its enlargement. A filler may be passed through lumen 708. Tubing manifolds and connections may be provided as desired for the function of the lumens.

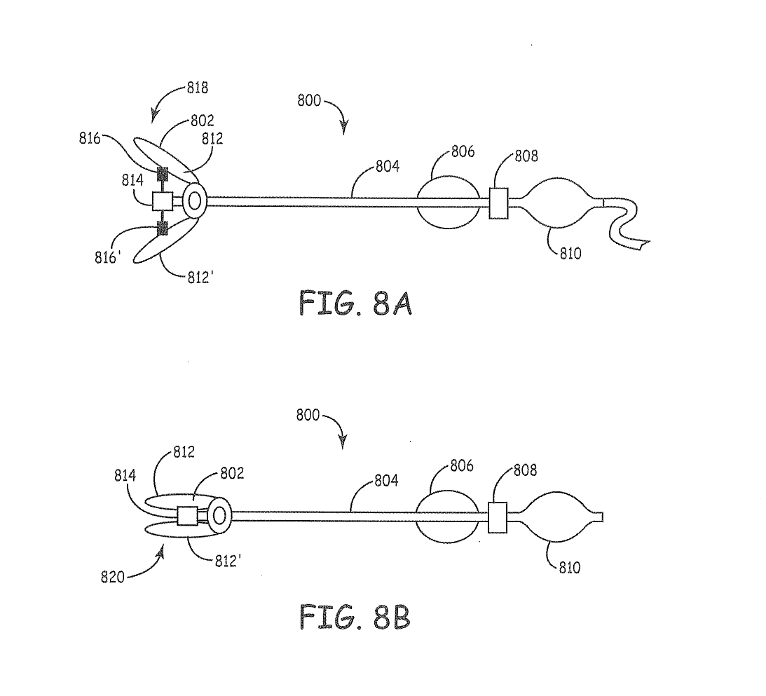

Hydraulic systems may also be used. An embodiment is an expandable member that is reversibly expandable by hydraulic force. FIGS. 8A-8B depict tool 800 having expandable member 802 mounted on rod 804 rotatably connector to rotator 806 and hydraulically connected to rotator coupling 808 and hydraulic motor 810. Expandable member 802 has a plurality of blades 812, 812′, joined by a hydraulically actuated piston driver 814 having pistons 816, 816′. Actuation of piston driver 814 provides for movement of expandable member 802 between a (fully) expanded position 818 and a collapsed position 820. The hydraulic motor 810 provides hydraulic force to open and close expandable member 802. Rotator coupling 808 provides for continuous hydraulic power during rotation of rod 804 while motor 810 is not rotated. Rotator 806 provides rotational force to rotate rod 804. Many mechanisms and tools for imparting rotation to a shaft are known. One embodiment is a bevel gear (for instance, spiral or straight), which is a gear connected to the rod that is turned by a second gear that is rotating. Another example is a worm gear. Another example is a plurality of gears, with one gear being affixed to the shaft.

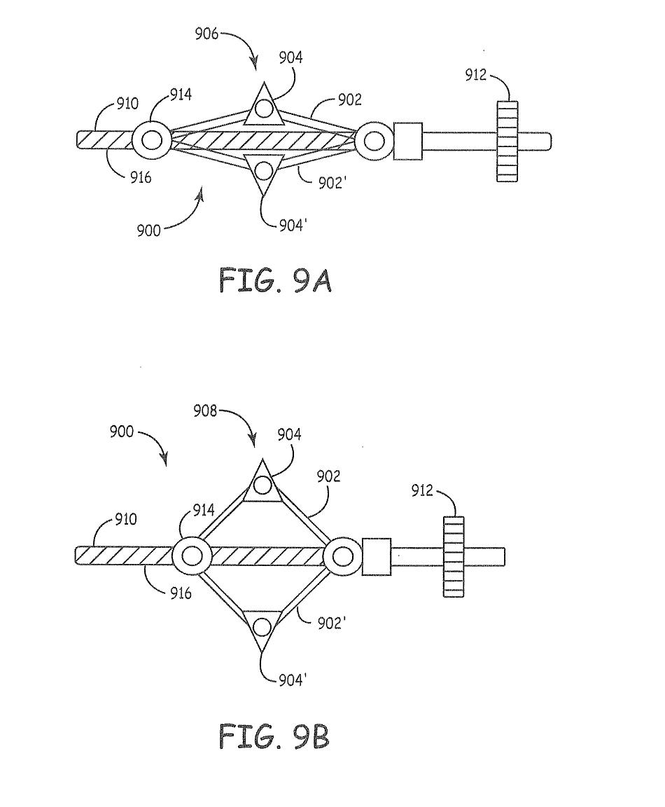

Another embodiment of an expandable member is presented in FIGS. 9A and 9B. A plurality of hinged cutters 902, 902′ with hinges 904, 904′ are moved between expanded position 906 and collapsed position 908. Rotation of shaft 910 by rotation of gear 912 causes pivoting connector 914 to travel up and down threaded portion 916 of shaft 910. This mechanism employs mechanical linkages as known to be used for scissor jacks.

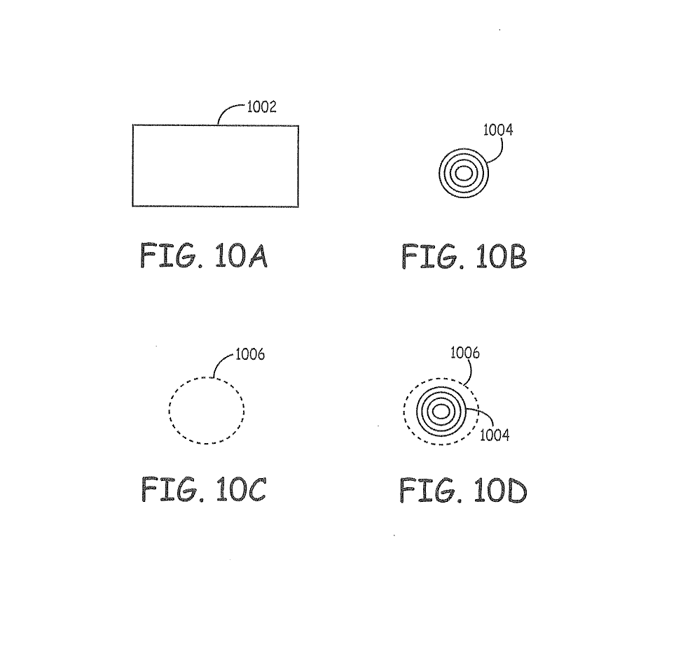

A larger cavity inside a fleshy food may be filled with foods capable of being folded into smaller forms that can pass through a narrow opening on the food surface. The concepts is schematically shown in FIGS. 10A-10D. A filler may comprise a folded food. FIGS. 10A-10D are a schematic for folding a food. The term folding is broad and includes rolling. At FIG. 10A, a substantially flat food 1002 is depicted. Examples of a flat food are: meat, cheese, bacon, and foods sliced or otherwise processed to be substantially flat. The flat food 1002 is rolled up into a roll 1004 that is sized to pass into opening 1006 in another food item. The roll 1004 is passed through opening 1006, as at FIG. 10D.

Many foods such sliced meats, dry fruit rolls and the like can be folded into a shape capable of fitting inside the narrow opening and then unrolled in-situ inside a fruit cavity. In the original shapes, larger foods cannot be filled inside a cavity unless they are folded into smaller shape. Many methods of folding can be used and these include but not limited to methods such as rolling a sheet into cylindrical shape or folding methods described in origami art. Upon inserting into a cavity, it is preferred that the folded foods can be unrolled or unfolded partially or substantially into its original shape. In one exemplary embodiment, a cooked turkey breast meat is cut into 2×1×0.04 inch size slice. A medium size potato is provided with an artificial cavity inside the potato body using methods described herein. The volume of cavity created is 4-6 cubic inches and has an about 0.2 to about 0.4 inch diameter access entry hole on the potato surface. The meat slice is first rolled into to cylinder like shape along the 1 inch size length. The rolled shape diameter is less than 0.4 inch. If necessary, other tools such as metal rod may be used to assist in folding as well as inserting the rolled shape inside the fruit cavity. The rolled piece is the then pushed inside the cavity. A long tweezer may be used to unroll the meat slice inside the cavity. The cavity may be additionally filled using shredded mozzarella cheese and the potato is baked in an oven.

When tools are used in making cavity, they may have to pass through the narrow opening in the food surface. When pushing tools through the narrow opening, the tools may encounter frictional forces. The frictional forces may be reduced by using low friction materials on a portion of the tool that contacts the food, for example, polytetrafluoroethylene, high density polyethylene, polyethylene, polypropylene, and the like. For example, a surface may be coated/bonded with low friction materials such as polytetrafluoroethylene.

Embodiments may include a comestible or food-safe lubricant. Such lubricants may be used to reduce the friction encountered during the operation of a tool. The lubricants that may be used include various oils such as edible oils (olive oil, peanut oil, corn oil etc.), synthetic oils like waxes or hydrocarbon oils and the like. Further options include aqueous surfactant solutions, e.g., soap solutions and detergent solutions. Further options are the use of hydrophilic polymers and/or solutions of the same; for example, polyacrylic acid or polyethylene glycol; neat liquids like polyethylene glycol molecular weight 200 to 2000 g/mole, and polypropylene glycol molecular weight 200 to 20000 g/mole. Suitable lubricants include, for example, polyethylene glycol based lubricants, natural oils and synthetic oils such as silicone oils and natural or synthetic surfactant solution like TWEEN 40 surfactant solution. In the preferred embodiments, a food surface may be lubricated or coated with few drops of silicone oil prior to use. Silicone oils are added prior in the internal lumen surface and spread evenly on the entire lumen surface. The other tools are then inserted via a lubricated opening which encounters significant low friction during the use. Embodiments include treating a tool or a food with a lubricant and making an opening in a food object, or otherwise in combination with other embodiments set forth herein.

Other embodiments are directed to the infusion of substance into a fruit/vegetable cavity or flesh. The substance may be water soluble. An example is an artificial sweetener. If not present naturally, a cavity inside the fruit is created and is accessed using minimally invasive methods as already described. After accessing the cavity, the cavity is filled with a solution, e.g., a sugar solution or SPLENDA solution to infuse or diffuse sugar inside the fruit flesh. The solution may be contacted up to 3 days at ambient temperature to achieve desirable diffusion of sugar or SPLENDA in the fruit flesh; artisans will immediately appreciate that all the ranges and values within the explicitly stated ranges are contemplated, e.g, from about 1 hour to about 72 hours, or about 48 hours. The diffusion of agent can be enhanced by several means and these include, for example: controlling the temperature, pressure and concentration of the system as well as stirring the solution or applying ultrasonic energy to the solution. In some cases, fruit may be subjected to centrifugal force by rotating the fruit during incubation. The temperature of the solution is limited by the tolerance of the fruit to high temperature. The preferred temperature range is less that 50° C., even more preferably less than 40° C.; artisans will immediately appreciate that all the ranges and values within the explicitly stated ranges are contemplated, e.g., from 0° C. to 50° C., or from about 4° C. to about 30° C., or from about 20° C. to about 50° or about 60° C. The concentration of agent to be diffused may also be varied. Pressure of the solution may also be changed to obtain a desirable effect. The pressure could be exerted by subjecting the assembly to an inert gas pressure such as nitrogen or argon gas.

Another embodiment is carbonation of a food, e.g., fruit. The carbonation of water provides a flavor, distinct mouthfeel, and anti-microbiological effects. In one example, water inside the coconut is carbonated. The water inside a mature or semi-mature coconut is accessed by drilling a small hole inside the fruit body. The accessed hole is then used to infuse carbon dioxide gas inside the coconut water. After achieving a desirable carbonation level, the carbonation line is disconnected and the access port (opening) is sealed in a manner that the carbonation can not escape and the carbonation level is maintained. Other agents such as sugar, artificial sweeteners, colorants, vitamins, salts may also be added to achieve a desired taste. Most fruits have flesh with very high water content. Some of the water inside the fruit flesh is free and can be used to dissolve carbon dioxide for carbonation purpose. The carbonation of fruit water content such as water inside a water melon or cantaloupe may potentially improve antimicrobial resistance of the fruit thus increasing its useful life or shelf life. Embodiments include a fruit that comprises exogenous carbonation (as distinct from natural carbonation by fermentation). The carbonation may be introduced with or without the creation of a cavity. Embodiments include placement of a plurality of cavities into a fleshy food. The cavities may be made by using the same opening, or by making new openings. The cavities may each have the same filler, or one or more cavities could have different fillers. For instance, a food could have at least two cavities (or between 2 and 10 cavities), with at least two of the cavities having fillers that are distinct from each other. In other embodiments, a cavity is filled with a plurality of layers. Each layer is a distinct composition. For instance, a first layer might comprise chocolate and second layer might comprise strawberry flavoring. One method for layering is to send a first layer through a tube into the cavity, and then to move the distal end of the tube closer to the opening, and supply the second layer. Embodiments include a fruit with at least one cavity wherein the filler comprises a plurality of distinct layers of comestible materials.

Some embodiments are directed to removing seeds from a food. Many fruits, for example fruits like peaches, papaya, or cantaloupe are sold with seeds present in the fruit cavity. The seeds are generally removed prior to consuming the fruit. Methods as described herein provide fruit may be made seedless without substantially affecting the physical appearance of the fruit. One such method is to use the cavity-creating tools to penetrate into the seed area and create a cavity. In the case of soft foods, a vacuum or cavity-creation in combination with vigorous washing is adequate. Harder seeds require a harder tool, for instance, a tool comprising a blade, burr, or hard substance. Removal of a hard seed is referred to as making a cavity because there is no actual cavity in the food until the seed is removed, e.g, a peach.

A cavity may be coated on its interior surface with a filler. A subsequent filler may then be placed in the cavity, or not. The cavity may be artificially created or naturally occurring. In one embodiment, a tube is equipped with a sprayer that sprays the filler on the cavity as the sprayer is rotated. In another embodiment, a filler is allowed to flow through the cavity, which is then vacuumed. For instance, a device or tool such as syringe with a needle that is capable of spraying, injecting or bruising is inserted in the fruit cavity and an agent is spray/brush coated on the cavity surface or injected inside the fruit flesh. Sprayers from the medical arts may be adapted.

Moreover, a food as treated herein may be further coated on its exterior. Spray-coating, dip-coating, and other coating processes known in these arts may be employed. A material described herein as an agent or filler may be applied to all or a portion of an external surface of a food. For instance, coating processes for apples are well known.

An embodiment of the invention is a method for treating a fleshy food comprising: passing a tool into the food through an opening; making a cavity inside the food with the tool, with the cavity comprising a cross-section that is too large to be passed through the opening; and withdrawing the tool. An embodiment of the invention is a food composition comprising a filler in an artificial cavity internal to a food, with the food having an opening into the cavity, with the cavity comprising a cross-section that is too large to be passed through the opening. An embodiment of the invention is a tool having an expandable member that is expandable to an expanded position to make a cavity in the food and collapsible to a collapsed position for withdrawal from the food, with the expandable member in the expanded state comprising a cross-section that is larger than the maximum diameter of the tool in the collapsed position. An embodiment of the invention is the method, the composition, or the tool further comprising or wherein: (i) the opening is a circular hole with a diameter of about 3 mm, and the cavity cross-section is an ellipse of about 4 mm in minor diameter; (ii) the opening has a shape chosen from the group consisting of a circle, an ellipse, and a rectangle; and/or the cavity has a shape chosen from the group consisting of a sphere, a cone, a cube, and a polyhedron; (iii) further comprising placing a comestible filler inside the food; (iv) the comestible filler is passed through a lumen of the tool into the cavity to load the filler into the cavity; (v) the filler is chosen from the group consisting of ice cream, peanut butter, cream, yogurt, fruit jam, and fruit jelly; (vi) passing the tool into the food creates the opening; (vii) the tool is introduced in a collapsed state when passed through the opening, and further comprising expanding the tool to an expanded state to make the cavity, and collapsing the tool to a collapsed state for withdrawal from the food; (viii) further comprising placing a tube into the food, wherein the tool is passed through the tube in the collapsed state, expanded after passage through the tube, and withdrawn through the tube in the collapsed state; (ix) the tube comprises a plurality of lumens, with the tool being passed through a first lumen and with removal of food flesh displaced by creation of the cavity being performed through the second lumen; (x) the tool comprises an inflatable balloon that is expandable by inflation to create the cavity; (xi) the tool comprises an extendible arm that is extended inside the food, and rotating the arm inside the food to create the cavity; (xii) the tool comprises a lumen, and further comprising withdrawing flesh of the food through the lumen by suction; (xiii) further comprising placing a closure over the opening; (xiv) the food outer skin, with the exception of the opening, is unbroken; (xv) the opening is a circular hole with a diameter of about 2 mm, and the cavity comprises a circular cross-section of about 5 mm in diameter; (xvi) the opening has a shape chosen from the group consisting of a circle, an ellipse, and a rectangle; and the cavity has a shape chosen from the group consisting of a sphere, a cone, a cube, and a polyhedron; (xvii) the filler is chosen from the group consisting of ice cream, peanut butter, cream, yogurt, fruit jam, and fruit jelly; (xviii) further comprising at least one more cavity, with the plurality of cavities sharing the opening; (xix) further comprising a closure over the opening (xx) wherein the food outer skin, with the exception of the opening, is unbroken; (xxi) wherein the cavity has a volume of more than about 1.5 ml; (xxii) an access path connects the cavity to the opening, with the access path comprising a bend of at least about 30 degrees; (xxiii) the filler is a continuous solid that substantially fills the cavity and has a hardness exceeding a hardness of flesh of the food surrounding the cavity; (xxiv) the tool comprises at least one lumen that has a first opening outside the food and a second opening inside the food when the expandable member is inside the food; and/or (xxv) the expandable member comprises an inflatable balloon, an extendible arm, or a blade. Embodiments of the invention include combinations and sub combinations of items 1-xxv.

All references and publications set forth herein are hereby incorporated by reference herein for all purposes; in case of conflict, this specification controls. The invention has been described with certain embodiments having particular features; these features may generally be mixed-and-matched to make other embodiments. For instance, some tools and methods are exemplified herein in the context of making a cavity that is relatively larger than the opening in the food that is used to make the cavity. Such tools and methods, however, can be used to make any sized cavity, or for other methods.

1. A tool comprising:
an expandable member that is expandable to an expanded position to make a cavity in a food and collapsible to a collapsed position for withdrawal from the food, with the expandable member in the expanded state comprising a cross-section that is larger than the maximum diameter of the tool in the collapsed position.

2. The tool of claim 1, wherein the tool comprises at least one lumen that has a first opening outside the food and a second opening inside the food when the expandable member is inside the food.

3. The tool of claim 1, wherein the expandable member comprises an inflatable balloon, an extendible arm, or a blade.

4. The tool of claim 1, further comprising a scale indicating a depth of penetration of a distal portion of the tool while making cavity.
